(19) United States
(12) Patent Application Publication
(10) Pub. No.: US 2008/0175652 A1
(43) Pub. Date: Jul. 24, 2008

(54) Ring Binder Mechanism

(75) Inventors: Hung Yu Cheng, Hong Kong (CN); Ze Yu Zhang, NeiJiang City (CN)

Correspondence Address: SENNIGER POWERS LLP, ONE METROPOLITAN SQUARE, 16TH FLOOR, ST LOUIS, MO, 63102, US

(73) Assignee: WORLD WIDE STATIONERY MFG. CO., LTD., Hong Kong (CN)

(21) Appl. No.: 11/624,547

(22) Filed: Jan. 18, 2007

(51) Int. Cl. B42F 13/20

(52) U.S. Cl. 402/38

(57) ABSTRACT

A ring mechanism comprises a housing, hinge plates, and ring members mounted on the hinge plates for retaining pages on the mechanism. An actuating lever is mounted on the housing for engaging the hinge plates and pivoting them to selectively move the ring members between an open position and a closed position. A travel bar is provided to block unintentional pivoting movement of the hinge plates when they are in the closed position. The lever pivots in a direction from one lateral side of the housing toward the other lateral side of the housing, i.e., about an axis that is oriented perpendicularly to the longitudinal axis of the housing and that extends upwardly relative to the housing. A ramped surface on the lever, e.g., a helical surface or a cam surface, engages the hinge plates to drive them to their open configuration.

### BACKGROUND OF THE INVENTION

This invention relates to a ring binder mechanism for retaining loose-leaf pages, and in particular to an improved ring binder mechanism for opening and closing ring members and for locking closed ring members together.

A ring binder mechanism retains loose-leaf pages, such as hole-punched pages, in a file or notebook. It has ring members for retaining the pages. The ring members may be selectively opened to add or remove pages or closed to retain pages while allowing the pages to be moved along the ring members. The ring members mount on two adjacent hinge plates that join together about a pivot axis. An elongate housing loosely supports the hinge plates within the housing and holds the hinge plates together so they may pivot relative to the housing.

The undeformed housing is slightly narrower than the joined hinge plates when the hinge plates are in a coplanar position (180°). So as the hinge plates pivot through this position, they deform the resilient housing and cause a spring force in the housing that urges the hinge plates to pivot away from the coplanar position, either opening or closing the ring members. Thus, when the ring members are closed the spring force resists hinge plate movement and clamps the ring members together. Similarly, when the ring members are open, the spring force holds them apart. An operator may typically overcome this force by manually pulling the ring members apart or pushing them together. Levers may also be provided on one or both ends of the housing for moving the ring members between the open and closed positions. But a drawback to these known ring binder mechanisms is that when the ring members are closed, they do not positively lock together. So if the mechanism is accidentally dropped, the ring members may unintentionally open.

Some ring binder mechanisms have been modified to include locking structure to block the hinge plates from pivoting when the ring members are closed. The blocking structure positively locks the closed ring members together, preventing them from unintentionally opening if the ring mechanism is accidentally dropped. The blocking structure also allows the housing spring force to be reduced because the strong spring force is not required to clamp the closed ring members together. Thus, less operator force is required to open and close the ring members of these mechanisms than in traditional ring mechanisms.

Some of these ring mechanisms incorporate the locking structure onto a control slide connected to the lever. The lever moves the control slide (and its locking structure) to either block the pivoting movement of the hinge plates or allow it. But a drawback to these mechanisms is that an operator must positively move the lever after closing the ring members to position the locking structure to block the hinge plates and lock the ring members closed. Failure to do this could allow the hinge plates to inadvertently pivot and open the ring members, especially if the mechanisms are accidentally dropped.

Some locking ring binder mechanisms use springs to move the locking structure into position blocking the hinge plates when the ring members close. Examples are shown in co-assigned U.S. patent application Ser. Nos. 10/870,801 (Cheng et al.), 10/905,606 (Cheng), and 11/027,550 (Cheng). These mechanisms employ separate springs to help lock the mechanisms.

Conventionally, the lever of the ring binder mechanism extends vertically relative to the binder mechanism housing, i.e., in the same direction as the rings. While in many ring binders the ring mechanism is attached to the spine of the binder, in other ring binders, the ring binder mechanism is attached to the back flap or cover of the ring binder. In those latter cases, the height of the lever (in its conventional orientation) is limited to the height of the rings; otherwise, the flaps or covers of the ring binder will not close properly. If the rings are relatively small and the lever is accordingly relatively short, greater force must be applied to the lever to open the ring binder mechanism because of the reduction in lever arm, which can make opening the binder mechanism difficult.

### SUMMARY OF THE INVENTION

In one aspect of the present invention, a ring mechanism for holding loose-leaf pages generally comprises a housing having a longitudinal axis. A pair of hinge plates is supported within the housing for pivoting movement relative to the housing between a first hinge plate position corresponding to a closed configuration of the mechanism and a second hinge plate position corresponding to an open configuration of the mechanism. Each of said hinge plates supports thereon two or more ring members. Each of the ring members on one of said hinge plates engages a corresponding ring member on the other of said hinge plates to form a continuous ring when the hinge plates are in said first hinge plate position and the mechanism is in said closed configuration. A lever is pivotally connected to the housing and arranged to pivot about an axis oriented perpendicularly to the longitudinal axis of the housing and extending upwardly relative to the housing. The lever has a camming surface which engages at least one of said hinge plates to drive the hinge plates from one of said first and second hinge plate positions to the other of said first and second hinge plate positions when the lever pivots from a first lever position to a second lever position.

Other features of the invention will be in part apparent and in part pointed out hereinafter.

### BRIEF DESCRIPTION OF THE DRAWINGS

FIG. 1 is an exploded perspective of a first embodiment of a ring binder mechanism according to the invention;

FIG. 2 is a perspective of the ring binder mechanism, showing it in a closed and locked configuration;

FIG. 3A is a perspective, FIGS. 3B and 3C are left and right side elevations, and FIG. 3D is a top plan view of a barrel of a lever of the ring binder mechanism;

FIG. 4 is a fragmentary perspective of the ring binder mechanism from the opposite end and with portions of a housing and a ring member broken away, showing the mechanism in a closed and locked configuration;

FIG. 5 is a fragmentary plan view of the ring binder mechanism with the housing and ring members removed, showing it in the closed and locked configuration;

FIG. 6 is a fragmentary side elevation of the ring binder mechanism with the housing and foreground ring member removed, showing the mechanism in the closed and locked configuration;

FIG. 7 is a fragmentary plan view similar to FIG. 5, but showing the ring binder mechanism in an intermediate position in the process of opening the rings;

FIG. 8 is a fragmentary side elevation similar to FIG. 6, but showing the ring binder mechanism in the intermediate position in the process of opening the rings;

FIG. 9 is a fragmentary plan elevation similar to FIG. 5, but showing the ring binder mechanism in an open and unlocked configuration;

FIG. 10 is a fragmentary side elevation similar to FIG. 6, but showing the ring binder mechanism in the open and unlocked configuration;

FIG. 11 is perspective of the ring binder mechanism from the bottom, showing it in the open and unlocked configuration;

FIG. 12 is an exploded perspective of a second embodiment of a ring binder mechanism;

FIG. 13 is a perspective of the ring binder mechanism of FIG. 12, showing it in a closed and locked configuration;

FIG. 14 is a fragmentary perspective showing the ring binder mechanism of FIG. 12 with a portion of the housing broken away, showing the ring binder mechanism in a closed and locked configuration;

FIG. 15 is a fragmentary plan view of the ring binder mechanism of FIG. 12 with a portion of the housing removed, showing it in the closed and locked configuration;

FIG. 16 is a fragmentary side elevation of the ring binder mechanism of FIG. 12 with a housing and a ring binder removed, showing it in the closed and locked configuration;

FIG. 17 is a fragmentary plan view similar to FIG. 15, but showing the ring binder mechanism in an intermediate configuration in the process of opening the rings;

FIG. 18 is a fragmentary side elevation similar to FIG. 16, but showing the ring binder mechanism in an intermediate configuration in the process of opening the rings;

FIG. 19 is a fragmentary plan view similar to FIG. 15, but showing the ring binder mechanism in an open and unlocked configuration;

FIG. 20 is a fragmentary side elevation similar to FIG. 16, but showing the ring binder mechanism in the open and unlocked configuration; and

FIG. 21 is a perspective of the embodiment of FIG. 12, showing the ring binder mechanism in the open and unlocked configuration.

Corresponding reference numbers indicate corresponding parts throughout the views of the drawings.

### DETAILED DESCRIPTION

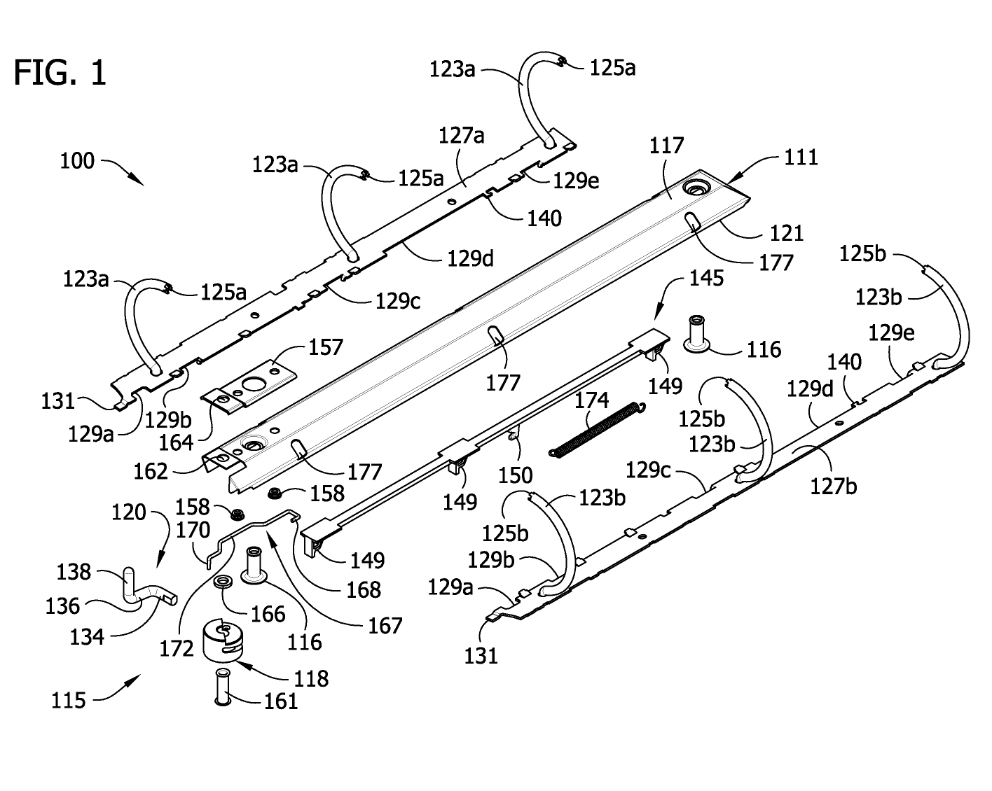

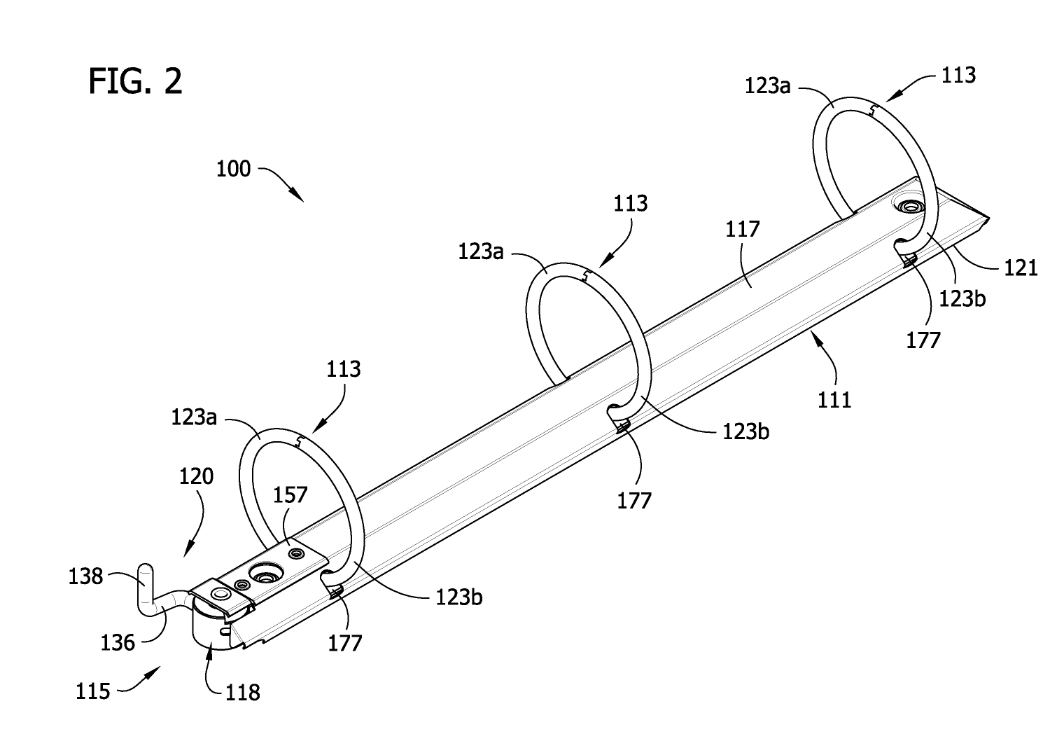

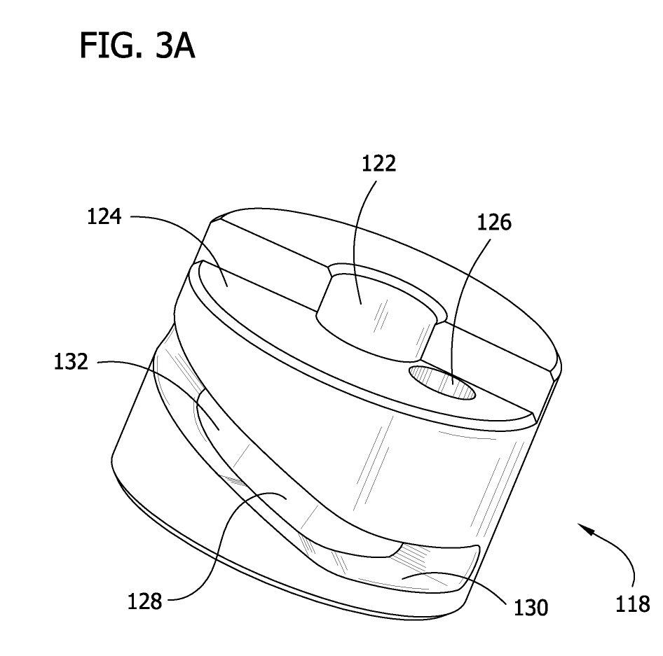

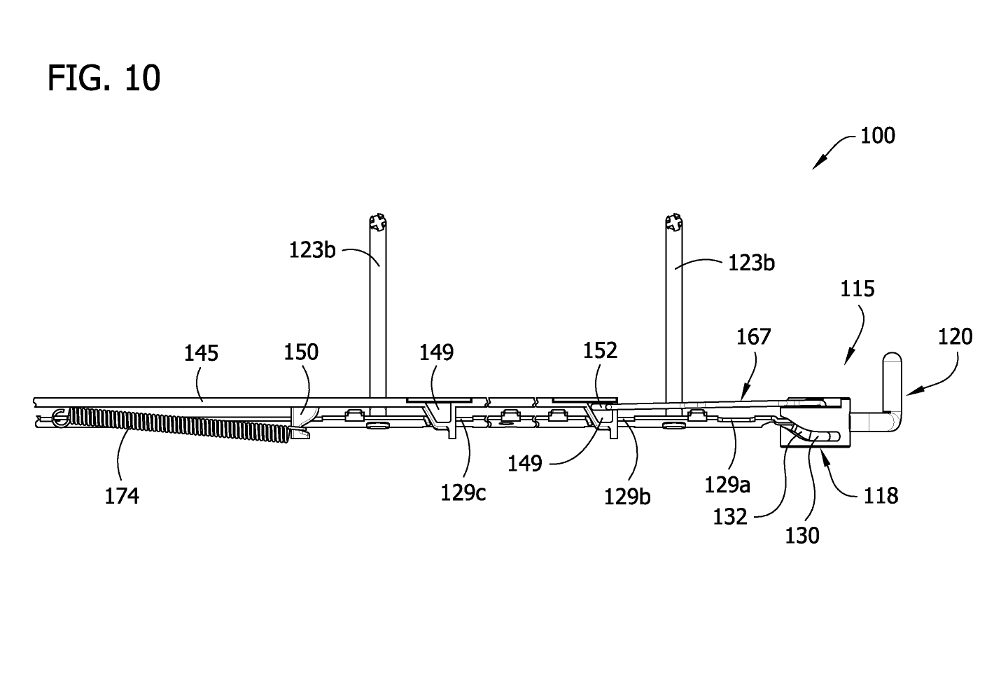

Referring to the drawings, FIGS. 1-11 show a first embodiment of a ring binder mechanism of the invention generally at 100. As shown in FIGS. 1 and 2, a housing, designated generally at 111, supports three rings (each designated generally at 113) and a lever (broadly, “actuator,” and designated generally at 115). The rings 113 retain loose-leaf pages on the ring mechanism 100 in a notebook (not illustrated) to which the ring mechanism 100 is attached in a suitable manner such as by rivets 116. The lever 115 is operable to open and close the rings so that pages may be added or removed. In general, the housing 111 is shaped as an elongated rectangle with a uniform, roughly arch-shaped cross section, having at its center a generally flat plateau 117. A first longitudinal end of the housing 111 (to the left in FIGS. 1 and 2) is generally open, while a second, opposite longitudinal end is generally closed. A longitudinal axis of the housing 111 (not specifically illustrated) extends from the open end to the closed end. Bent under rims, each designated at 121 (FIGS. 1, 2, and 4), extend lengthwise along longitudinal edges of the housing 111 from the first longitudinal end of the housing to the second longitudinal end. Mechanisms having housings of other shapes, including irregular shapes, or housings that are integral with a file or notebook do not depart from the scope of this invention.

The three rings 113 of the ring binder mechanism 100 are substantially similar and are each generally circular in shape (e.g., FIG. 1). The rings 113 each include two generally semi-circular ring members 123a, 123b formed from a conventional, cylindrical rod of a suitable material (e.g., steel). The ring members 123a, 123b include free ends 125a, 125b, respectively, formed to secure the ring members against transverse misalignment (relative to longitudinal axes of the ring members) when they are closed together (see FIG. 2). The rings 113 could be D-shaped as is known in the art, or otherwise shaped within the scope of this invention. Ring binder mechanisms with ring members formed of different material or having different cross-sectional shapes, for example, oval shapes, or having different free end constructions do not depart from the scope of this invention.

As also shown in FIG. 1, the ring mechanism 100 includes two substantially identical but mirror-image hinge plates, designated generally at 127a, 127b, supporting the ring members 123a, 123b. respectively. The hinge plates 127a, 127b are each generally elongate, flat, and rectangular in shape and are each somewhat shorter in length than the housing 111. Five corresponding cutouts 129a-e are formed in each of the hinge plates 127a, 127b along an inner edge margin of the plate, and a spring-hook 140 extends slightly into one of the cutouts (e.g., cutout 129d). A finger 131 extends longitudinally away from a first end of each of the hinge plates 127a, 127b (to the left in FIG. 1). The fingers 131 are each narrower in width than the respective hinge plates 127a, 127b and are bent downward out of plane with the hinge plates. The purpose of the cutouts 129a-e and fingers 131 will be described hereinafter. The lever 115 and hinge plates 127a, 127b can broadly be referred to as an “actuation system.”

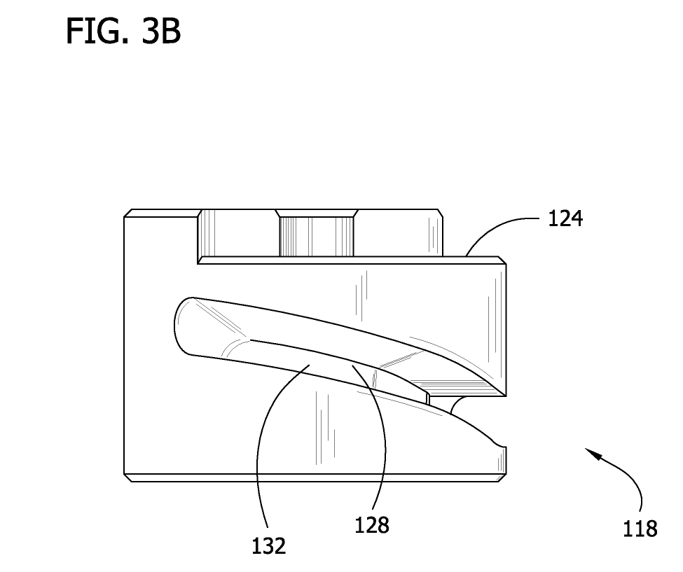

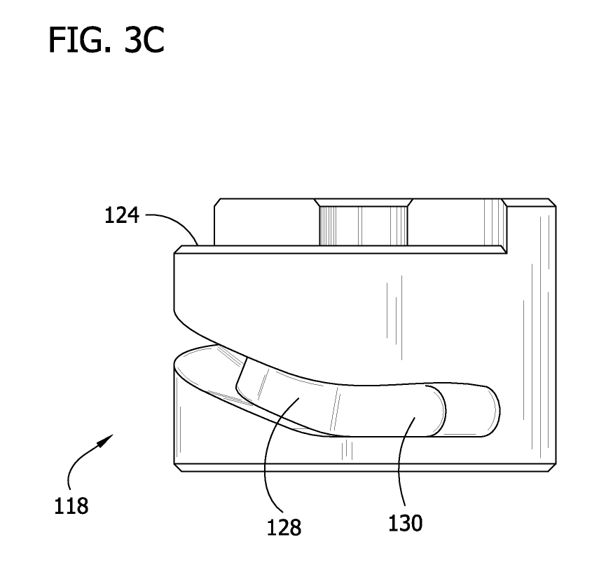

Referring to FIGS. 1, 2, and 3a-3d, the lever 115 includes a barrel 118 and a handle 120. As best shown in FIGS. 3a-3d, the barrel 118 is a generally cylindrical member with a central bore 122 extending all the way through it. Half of the upper surface of the barrel 118 is cut down slightly to a lower level than the other half so as to form a semicircular shelf 124, and a pin-receiving hole 126 extends downwardly from the shelf into the barrel. A generally helical slot 128 is cut into the sidewall of the barrel 118. The slot 128 includes a “tail” portion 130 that is aligned with or parallel to the lower and upper surfaces of the barrel 118 and an angled camming portion 132 that winds upwardly from the tail portion 130 toward the upper surface of the barrel 118.

A handle-receiving hole (not visible) is also formed in the sidewall of the barrel 118, and a stem portion 134 of the handle 120 (FIG. 1) is press-fit or otherwise suitable attached in the handle-receiving hole. As illustrated in FIG. 1, the end of the stem portion 134 is notched or otherwise shaped to provide a key-type fit into the handle-receiving hole. The handle 120 further includes an intermediate portion 136 that is bent laterally at approximately 90° relative to the stem portion 134, and a grip portion 138 that is bent upwardly at approximately 90° relative to the intermediate portion 136. Thus, when the handle 120 is press-fit into the barrel 118, the grip portion is oriented parallel to the central bore 122 of the barrel, and spaced radially outwardly from the sidewall of the barrel.

Referring again to FIG. 1, the ring mechanism 100 includes an elongated travel bar designated generally at 145. The travel bar includes three locking elements (each designated generally at 149) along a bottom surface, as well as a spring hook 150. The locking elements 149 are spaced apart longitudinally along the travel bar 145 with one locking element adjacent each longitudinal end of the travel bar, and one located toward a center of the travel bar. The travel bar 145 may have other shapes or greater or fewer than three locking elements 149 within the scope of this invention. The travel bar and locking elements may be broadly referred to as a “locking system.”

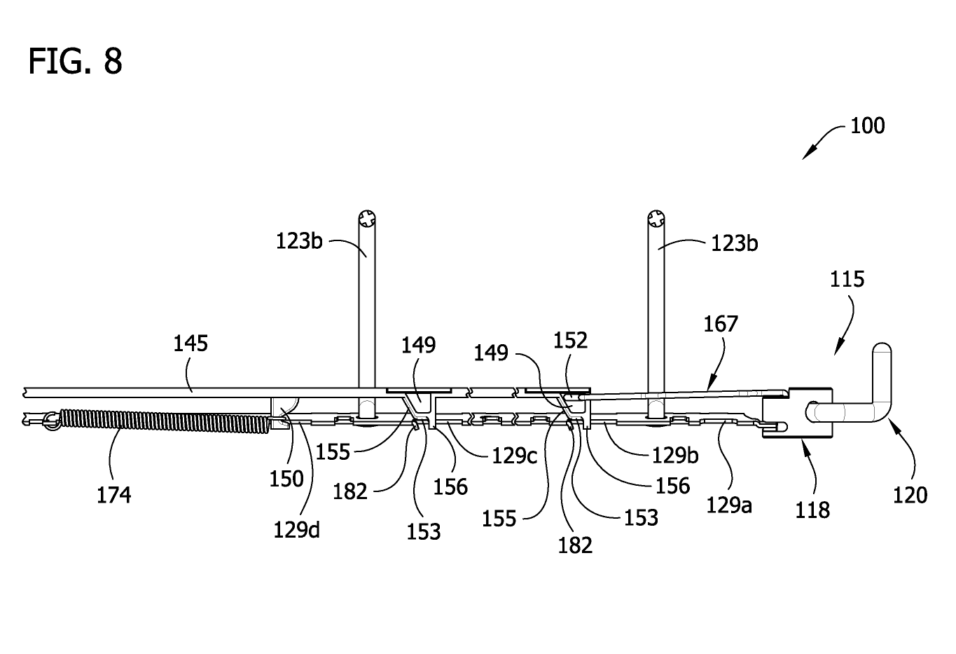

The locking elements 149 of the illustrated travel bar 145 are each substantially similar in shape. As shown more clearly in FIG. 8, each locking element 149 includes a narrow, flat bottom 153, an angled forward edge 155, and a rearward extension 156. In the illustrated embodiment, the locking elements 149 each have a generally wedge shape. The angled edges 155 of the locking elements 149 may engage the hinge plates 127a, 127b and assist in pivoting the hinge plates down. In the illustrated embodiment, the locking elements 149 are formed as one piece of material with the travel bar 145 by, for example, a mold process. The locking elements 149 may be formed separately from the travel bar 145 and attached thereto without departing from the scope of the invention. Additionally, locking elements with different shapes, for example, block shapes (e.g., no angled edges or recessed sides), are within the scope of this invention.

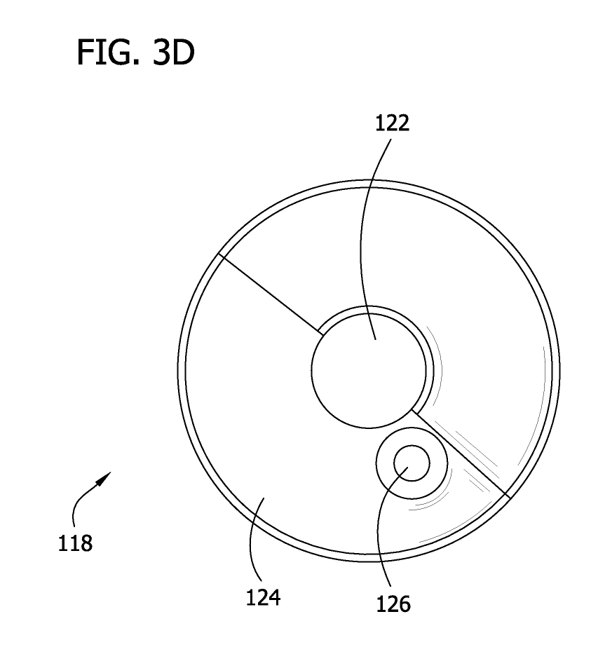

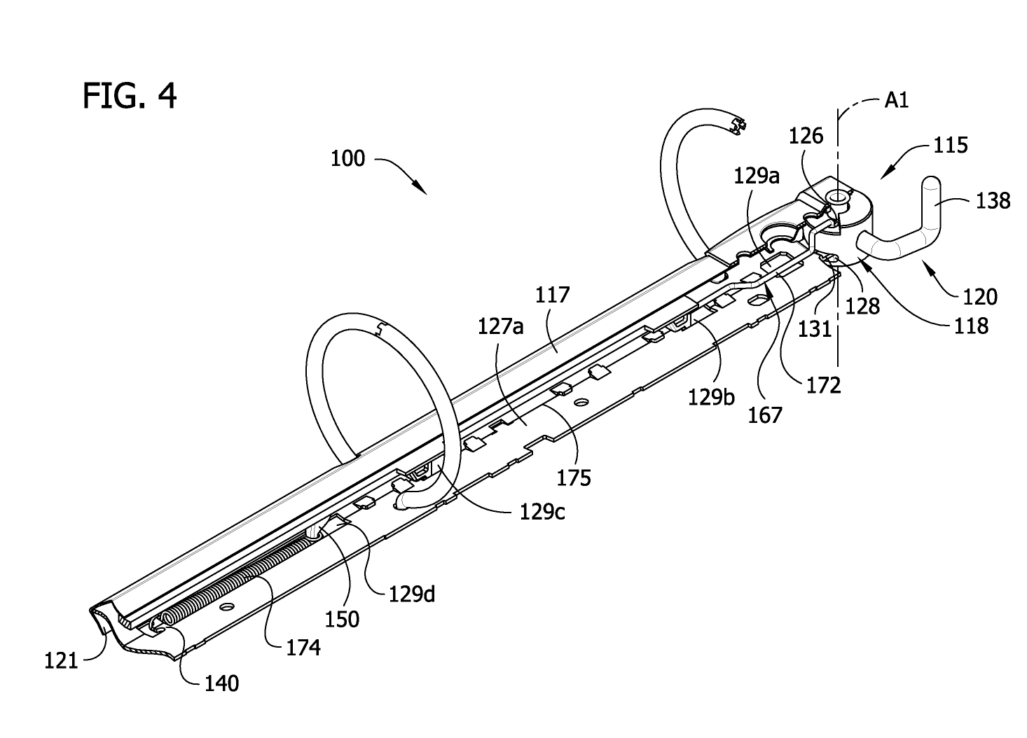

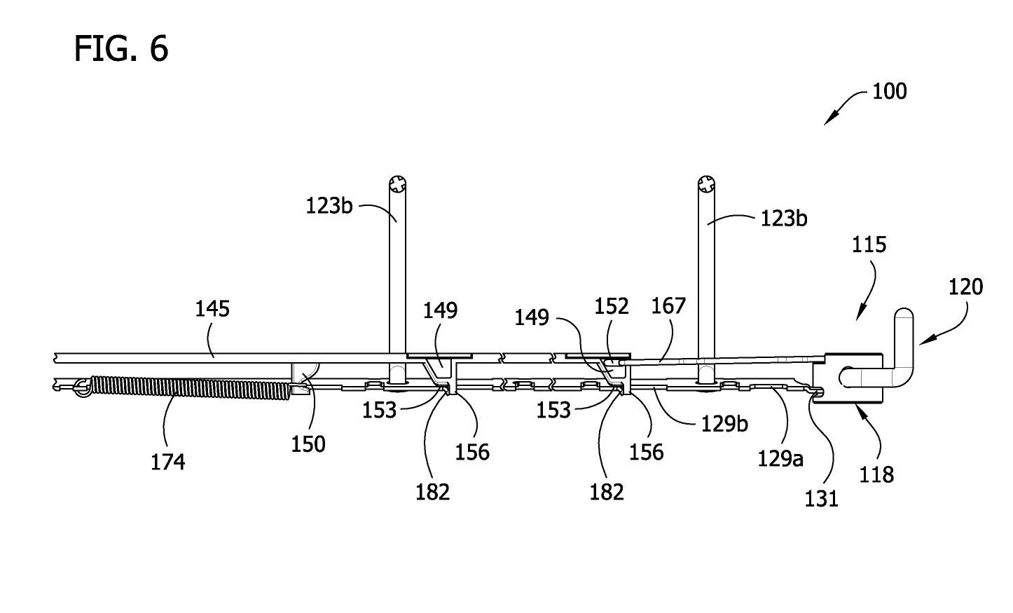

The ring binder mechanism 100 in assembled form will now be described with reference to FIGS. 1, 2, and 4 in which the mechanism is illustrated with the ring members 123a, 123b in the closed position. The lever 115 pivotally mounts on the first, open end of the housing 111, suitably with a lever mount 157 secured to the housing by rivets 158 to brace the housing and the mounting arrangement. More particularly, a pivot pin 161 passes through the central bore 122 in the barrel 118 and through aligned holes 162 and 164 in the housing 111 and the lever mount 157, respectively, and a washer 166 is provided to facilitate rotation of the barrel. The mounting arrangement is such that the lever 115 (most specifically the grip portion 138) pivots in a direction from one lateral side of the housing 111 toward the other lateral side of the housing, i.e., about an axis A1 that is oriented perpendicularly to the longitudinal axis of the housing and that extends upwardly relative to the housing. As is most visible in FIGS. 4 and 6, the fingers 131 of the hinge plates 127a, 127b extend into the helical slot 128.

As shown in FIG. 4, the travel bar 145 is disposed within the housing 111 generally beneath the housing's plateau 117. It extends lengthwise of the housing 111, in generally parallel orientation with the longitudinal axis of the housing, with the locking elements 149 extending toward the hinge plates 127a, 127b.

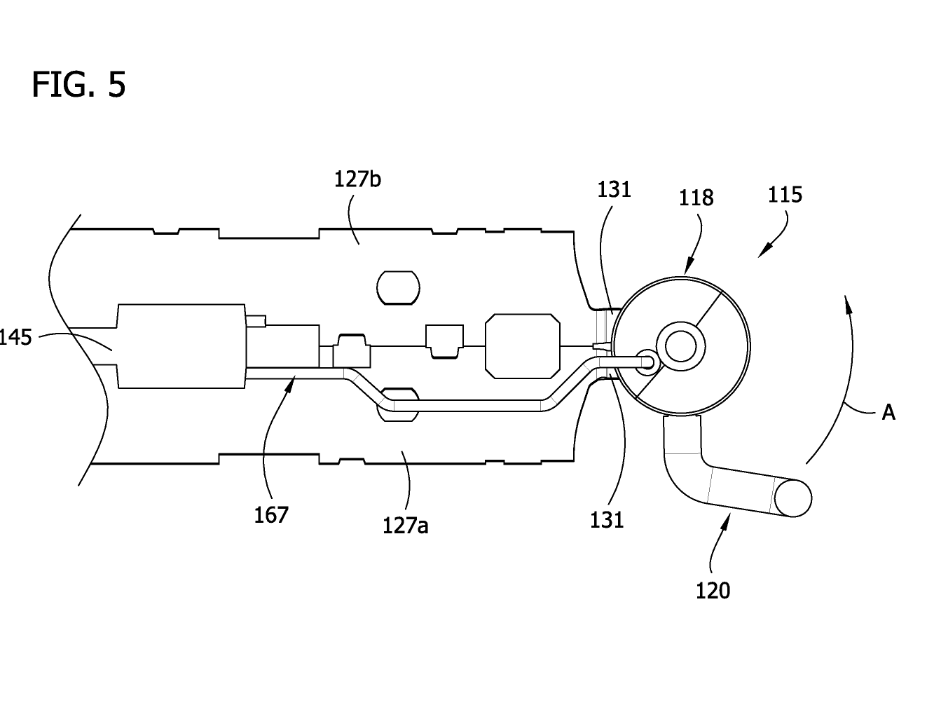

The travel bar 145 is operatively connected to the lever 115 by an intermediate connector, designated generally at 167. As illustrated, the intermediate connector 167 is a generally elongated member with a crook 168 formed at one end (FIG. 1) and a downwardly bent pin 170 formed at the opposite end. A lateral jog 172 may suitably be formed in the intermediate connector 167 to allow the intermediate connector 167 to pass around and slide back and forth past the rivet 116 that is closest to the open end of the housing 111. As best shown in FIG. 4, the pin 170 fits into the pin-receiving hole 126 formed in the barrel 118, and the crook 168 hooks through a slot 152 in the web of the locking element 149 that is closest to the lever 115 (as best shown in FIGS. 6, 8, and 10) to couple the lever 115 to the travel bar 145. See, also, FIGS. 5, 7, and 9. The hooked connection between the crook 168 of the intermediate connector 167 and the locking element 149 allows the intermediate connector 167 to pivot slightly relative to the travel bar 145 as the travel bar 145 moves up and down within the housing 111 (in addition to moving longitudinally).

In addition to being coupled to the lever 115, the travel bar 145 is also linked to the hinge plates—either 127a or 127b—by means of a return spring 174. In particular, the return spring is hooked at one end to the spring hook 140 extending from one of the hinge plates and at its opposite end to the spring hook 150 extending downwardly from the travel bar 145. The return spring 174 is stretched between the two return hooks 140, 150 to bias the travel bar 145 away from the lever 115 and toward a closed and locked configuration of the ring binder mechanism 100.

As best shown in FIG. 4, the hinge plates 127a, 127b are interconnected in parallel arrangement along their inner longitudinal edge margins, forming a central hinge 175 having a pivot axis. This is done in a conventional manner known in the art. As will be described, the hinge plates 127a, 127b can pivot about the hinge 175 upward and downward. The five cutouts 129a-e in each of the two individual hinge plates 127a, 127b align to form five openings also designated 129a-e in the interconnected plates. The opening 129a is located to receive the rivet 116 closest to the lever 115 through it, and the opening 129d receives the return spring 174 in it. The openings 129b, 129c, and 129e receive the blocking elements 149 when the mechanism is opened.

The housing 111 supports the interconnected hinge plates 127a, 127b within the housing below the travel bar 145. The outer longitudinal edge margins of the hinge plates 127a, 127b loosely fit behind the bent under rims 121 of the housing 111 for allowing them to move within the rims when the hinge plates pivot. As noted above, the fingers 131 of the hinge plates 127a, 127b extend into the helical slot 128 in the sidewall of the barrel 118.

As shown in FIGS. 1 and 2, the ring members 123a, 123b are each mounted on upper surfaces of respective ones of the hinge plates 127a, 127b in generally opposed fashion, with the free ends 125a, 125b facing each other. The ring members 123a, 123b extend through respective openings, each designated 177, along sides of the housing 111 so that the free ends 125a, 125b of the ring members can engage above the housing 111. The ring members 123a, 123b are rigidly connected to the hinge plates 127a, 127b as is known in the art and move with the hinge plates when they pivot. Although in the illustrated ring binder mechanism 100 both ring members 123a, 123b of each ring 113 are each mounted on one of the two hinge plates 127a, 127b and move with the pivoting movement of the hinge plates, a mechanism in which each ring has one movable ring member and one fixed ring member does not depart from the scope of this invention (e.g., a mechanism in which only one of the ring members of each ring is mounted on a hinge plate with the other ring member mounted, for example, on a housing).

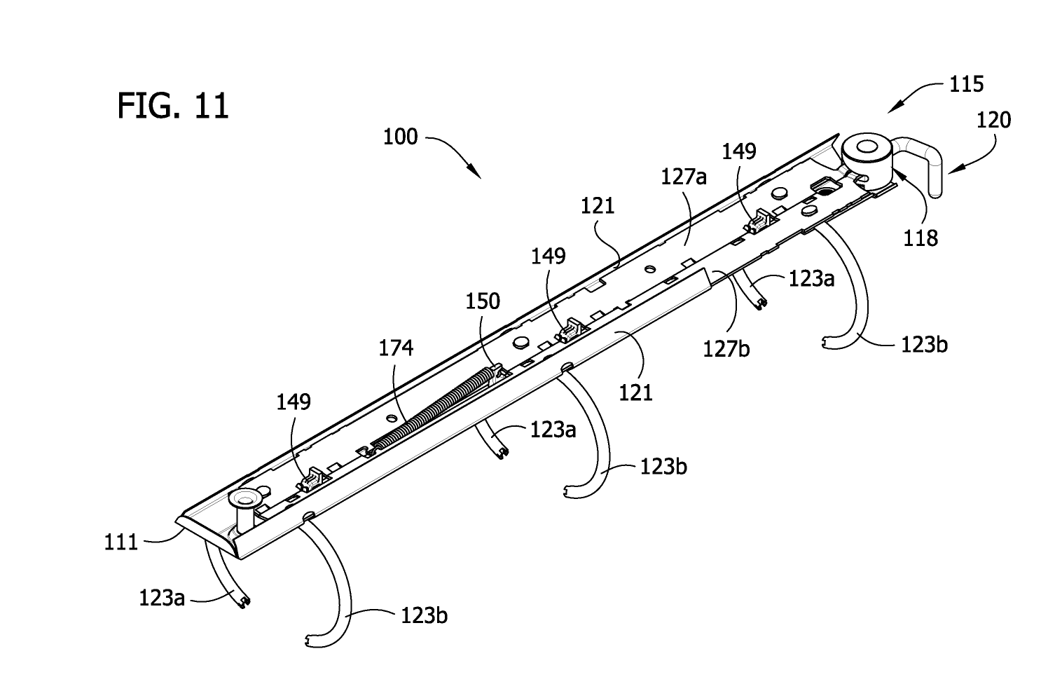

Operation of the ring mechanism 100 will now be described with reference to FIGS. 4-11. As is known, the hinge plates 127a, 127b pivot downward and upward relative to the housing 111 and move the ring members 123a, 123b mounted thereon between a closed position (e.g., FIGS. 2 and 4) and an open position (e.g., FIG. 11). The hinge plates 127a, 127b are wider than the housing 111 when in a co-planar position (180°), so as they pivot through the co-planar position, they deform the housing and create a small spring force in the housing. The housing spring force biases the hinge plates 127a, 127b to pivot away from the co-planar position, either downward or upward. The ring members 123a, 123b close when the hinge plates 127a, 127b pivot downward (i.e., the hinge 175 moves away from the housing 111); conversely, the ring members 123a, 123b open when the hinge plates 127a, 127b pivot upward (i.e., the hinge 175 moves toward the housing 111).

In FIGS. 4-6, the ring mechanism 100 is in a closed and locked position. The hinge plates 127a, 127b are hinged downward, away from housing 111, so that the ring members 123a, 123b of each ring 113 are together in a continuous, circular loop, capable of retaining loose-leaf pages. The lever 115 is in a first angular position, with the fingers 131 of the hinge plates residing in the tail portion 130 of the helical slot 128 in the barrel 118. The locking elements 149 of the travel bar 145 are positioned adjacent respective locking element openings 129b, 129c, and 129e (129e not visible) and above the hinge plates 127a, 127b generally aligned with the hinge 175. The locking elements 149 are substantially out of registration with the openings 129b, 129c, and 129e. The flat bottom surfaces 153 of the locking elements 149 rest on an upper surface of the hinge plates 127a, 127b and the rearward extensions 156 extend through each respective opening 129b, 129c, 129e adjacent down-turned tabs 182 of the plates. The return spring 174, which is in tension, holds the travel bar 145 and the locking elements 149 in this position, with rearward extensions 156 of the locking elements 149 limiting movement of the travel bar 145 away from the lever 115. Together, the travel bar 145 and locking elements 149 oppose any force tending to pivot the hinge plates 127a, 127b upward to open the ring members 123a, 123b (i.e., they lock the ring members closed).

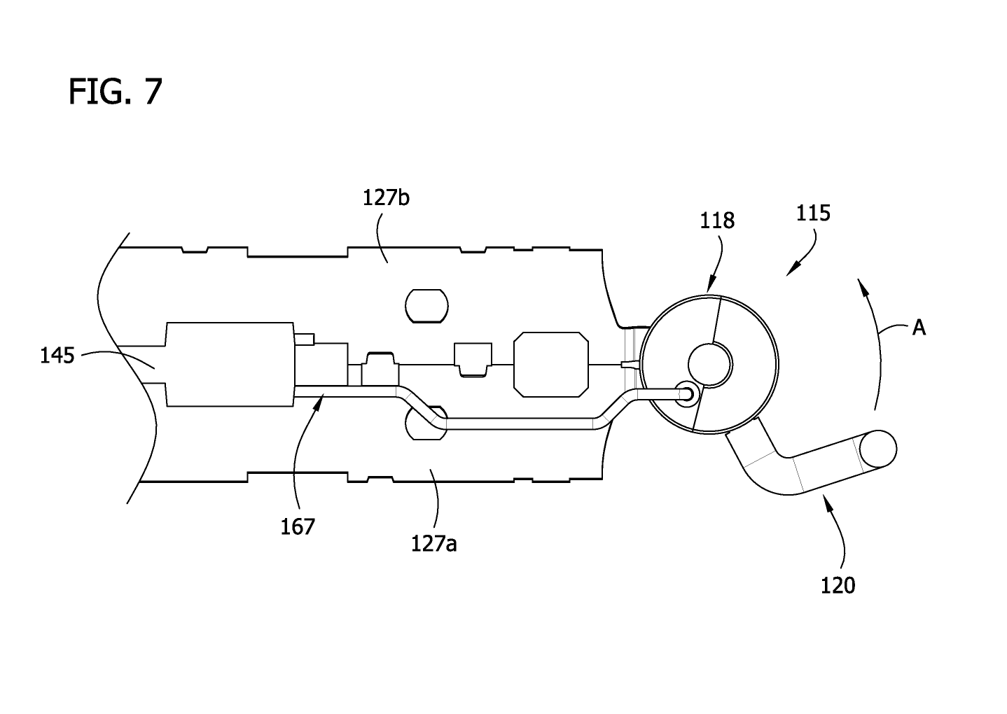

To unlock the ring mechanism 100 and open the ring members 123a, 123b, an operator applies force to the grip portion 138 of the lever handle 120 and pivots it about pivot pin 161, from the lateral side of the housing on which it rests toward the opposite side of the housing 111, e.g., in the direction of arrow A in FIGS. 5 and 7. In other words, the lever pivots about an axis that is oriented perpendicularly to the longitudinal axis of the housing and that extends upwardly relative to the housing. The intermediate connector 167 is simultaneously pulled by the barrel 118 in a direction generally toward the lever 115. The travel bar slides, against the biasing tension of the return spring 174, toward the lever 115 and moves the locking elements 149 into registration over the respective locking element openings 129b, 129c, and 129e of the hinge plates 127a, 127b, as shown in FIG. 8. Notably, because the tail portion 130 of the helical slot is oriented parallel to the lower and upper surfaces of the barrel 118 (and perpendicular to its axis of rotation A1), when the barrel rotates through this initial portion of the opening movement, no opening force is applied to the hinge plates 127a, 127b; this allows the travel bar 145 to slide easily into the position shown in FIG. 8, i.e. without the locking elements 149 binding against the upper surfaces of the hinge plates 127a, 127b.

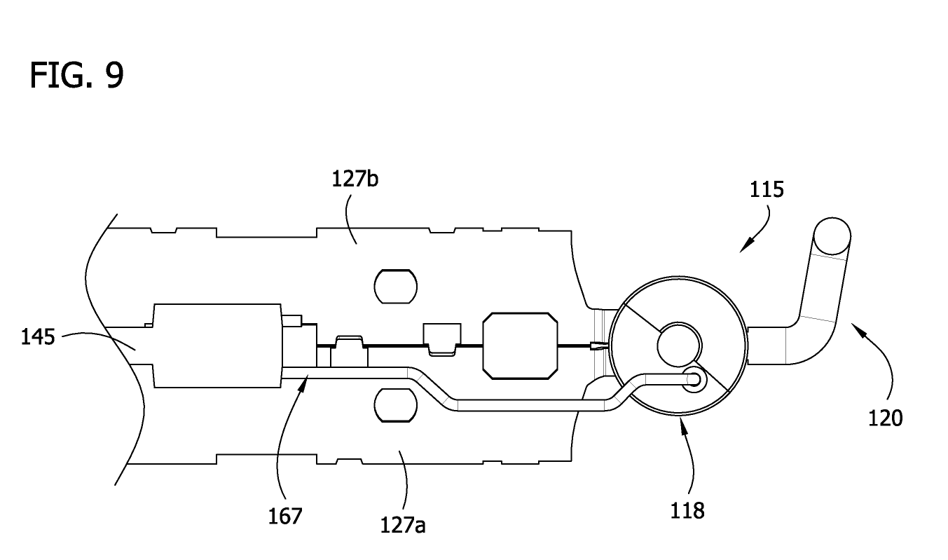

Continued rotation of the barrel 118 brings the sloped camming portion 132 of the helical slot 128 into engagement with the fingers 131 of the hinge plates 127a, 127b. In particular, the bottom surface of the camming portion 132 of the slot (“a first camming surface”) will press upward on the lower surfaces of the fingers 131 to apply upward opening pressure to the hinge plates 127a, 127b. That pressure causes the interconnected hinge plates 127a, 127b to pivot upward over the locking elements 149 at the locking element openings 129b, 129c, 129e and relative to the rivet 116 at the opening 129a. Once the hinge plates 127a, 127b pass just through the co-planar position, the housing spring force pushes them upward, opening the ring members 123a, 123b and holding them open (FIGS. 9-11), and the lever 115 can be released. (In the open position, the angled forward edges 155 of the locking elements 149 bear against the down-turned tabs 182, but the tension in the spring 174 is not large enough to act to force the hinge plates 127a, 127b downward.)

To close the ring members 123a, 123b and return the mechanism 100 to the locked position, an operator can pivot the lever 115 (and hence the barrel 118) in the opposite direction such that the upper surface of the camming portion 132 of the helical slot (“a second camming surface”) pushes downward on the fingers 131 of the hinge plates 127a, 127b. As the lever 115 continues to pivot, the upper surface of the camming portion of the slot bearing against the fingers 131 acts to push the hinge plates 127a, 127b downward. As the barrel 118 turns, the intermediate connector 167 is pushed toward the travel bar 145. The intermediate connector 167 is connected to the travel bar 145 via slot 152, so the intermediate connector 167 does not immediately push the travel bar 145. This lost motion connection between the intermediate connector 167 and the travel bar 145 allows the hinge plates 127a, 127b to pivot down before the travel bar 145 starts moving the locking elements 149 toward their positions behind the hinge plates. Once the hinge plates 127a, 127b pass just through the co-planar position, the housing spring force pushes them all the way downward, thus closing the ring members 123a, 123b, and the spring 174 pulls the travel bar 145 back to the locking position (e.g., FIG. 6).

In the illustrated mechanism 100, the ring members 123a, 123b can also be closed by manually pushing the free ends 125a, 125b of the ring members together.

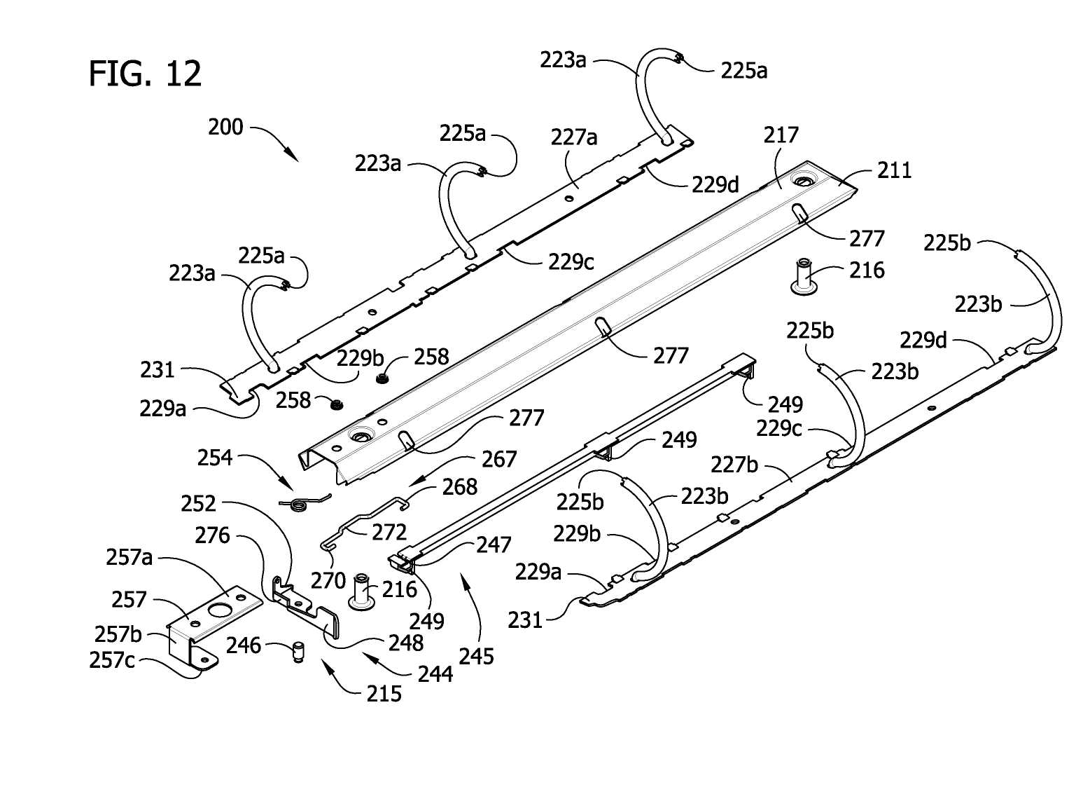

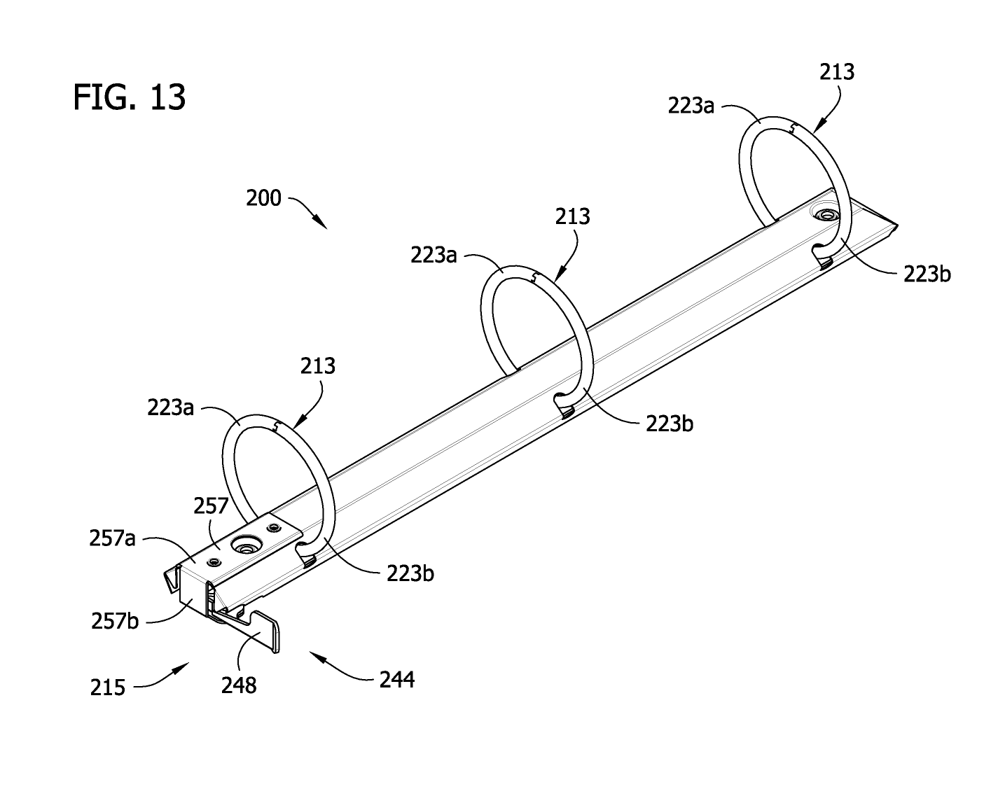

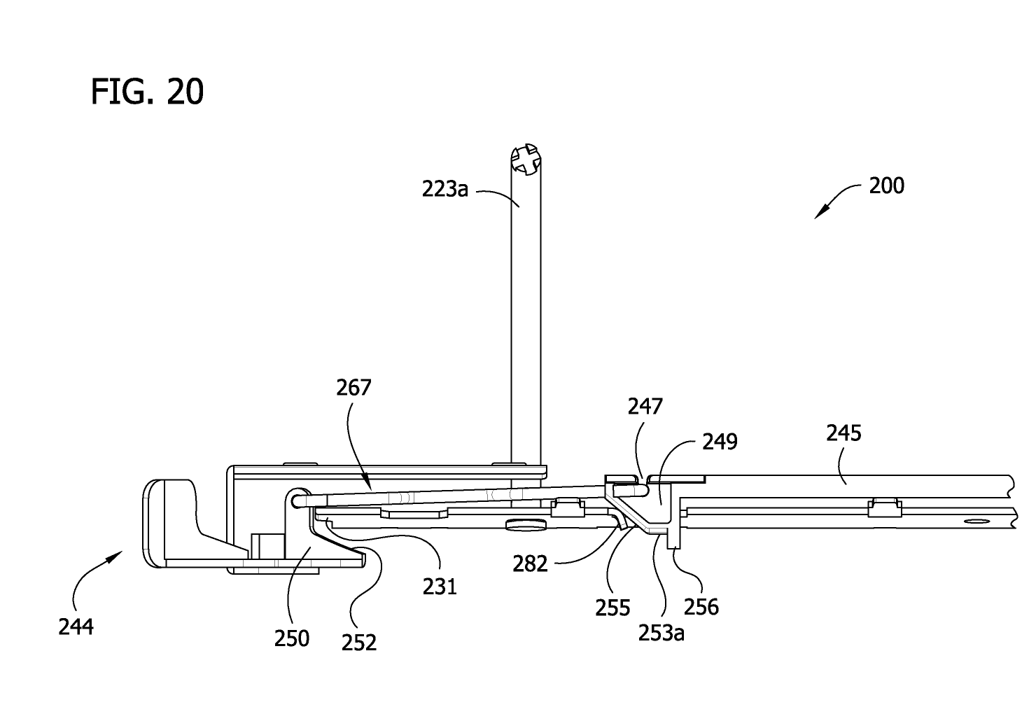

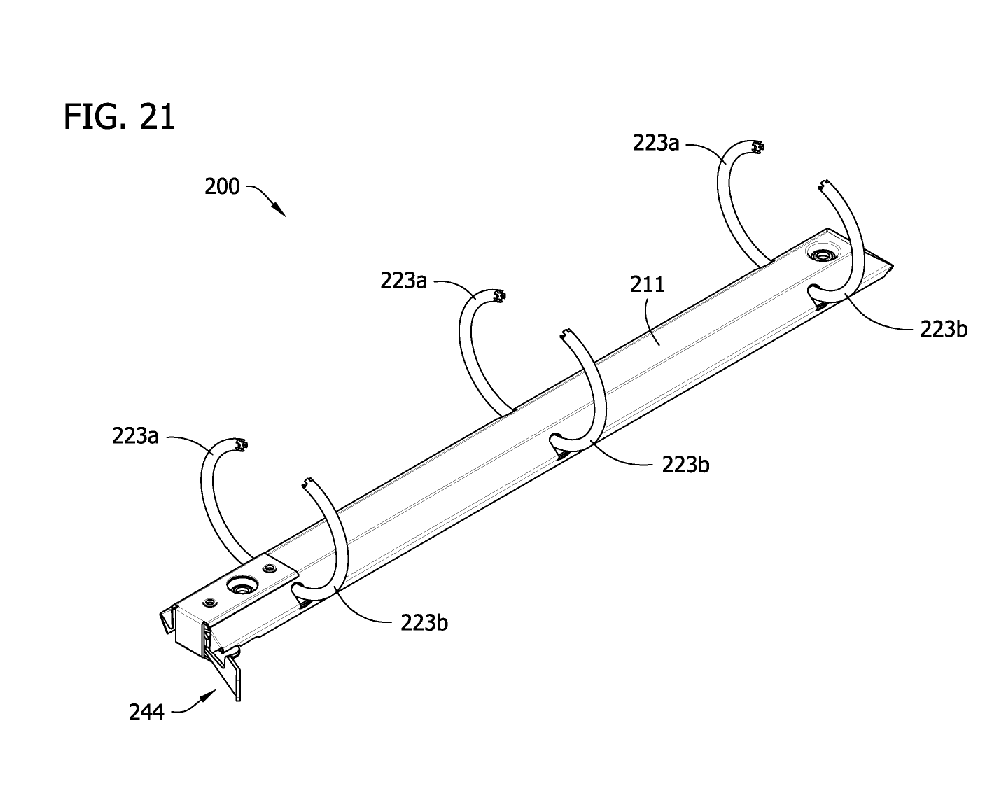

A second embodiment 200 of a ring binder mechanism according to the invention is illustrated in FIGS. 12-21. Components of the embodiment 200 that are the same as or similar to the components of the first embodiment 100 are labeled with corresponding reference numbers in the “200” series as opposed to the “100” series. In general, but still broadly speaking, the ring binder mechanism 200 includes a housing 211 in which hinge plates 227a and 227b are supported for pivoting motion between a first position in which the ring elements 223a and 223b are closed together to form rings 213 (FIG. 13) and a second position in which the ring elements 223a and 223b are spaced apart to permit sheets of paper to be added to or removed from the ring mechanism 200, in much the same fashion as described above with respect to the ring mechanism 100. A travel bar 245 is disposed behind the plateau 217 of the housing 211 and above the hinge plates 227a, 227b; the travel bar 245 slides back and forth between a locking position in which accidental opening of the rings 213 is prevented and an opening position in which opening of the rings 213 is enabled. Opening of the mechanism is controlled by means of a lever 215.

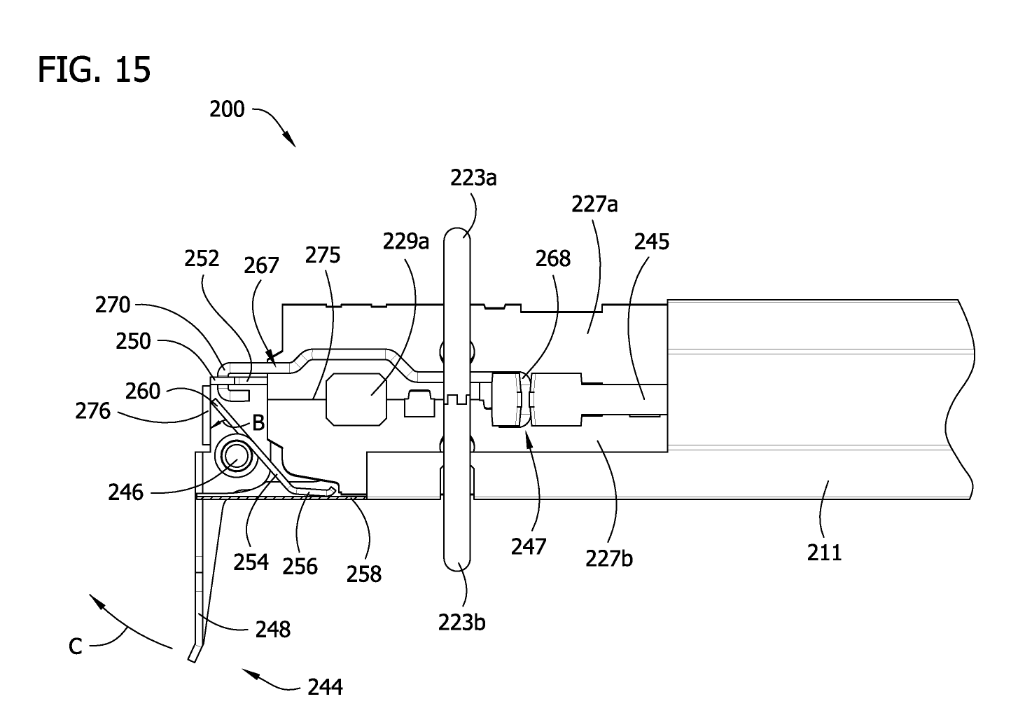

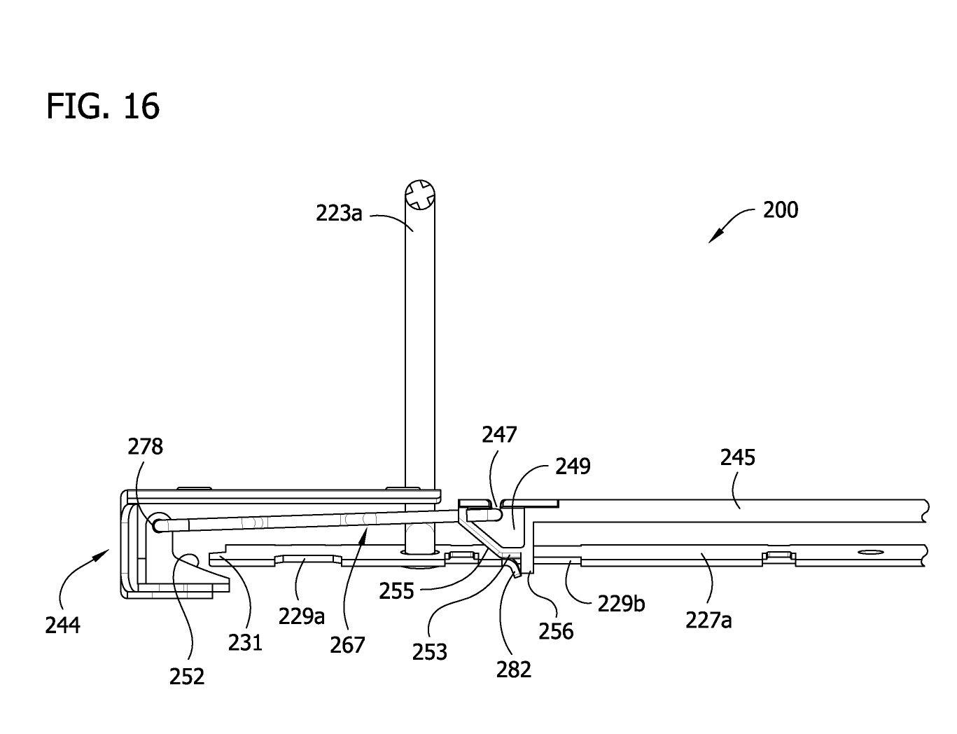

More particularly, details of the lever 215 and its interconnection with the travel bar 245 will be described with reference to FIGS. 12-15. As shown in those figures, a lever mount 257 is attached to the open end of the housing 211 by means of rivets 258. The lever mount 257 is a generally bracket-shaped member with a top wall 257a that lies flush against the plateau 217 of the housing 211; a depending end wall 257b that closes off the open end of the housing 211; and a support shelf 257c that extends from the end wall 257b and that is parallel to and spaced below the top wall 257a. A lever member 244 is pivotally supported on the support shelf 257c below the housing plateau 217, pin-fixed to the support shelf 257c by means of pivot pin 246. The lever member 244 includes a grip portion 248 at one end, which extends laterally beyond the housing 211, and an upstanding end wall 250 at the opposite end. The end wall 250 has an upper camming surface 252 that is oriented at an angle relative to the longitudinal axis of the housing 211 and to the axis of rotation of the lever member 244. (See FIGS. 16, 18, and 19.) A pivot spring 254 is disposed around the pivot pin 246, with one end 256 bearing against a sidewall 258 of the housing 211 and the opposite end 260 bearing against spring pad portion 276 of the lever member 244. The pivot spring 254 acts to bias the lever member 244 toward the position shown in FIG. 15 corresponding to the closed and locked configuration of the ring binder mechanism 200. In other words, the biasing force acts to pivot the lever member 244 in the direction of arrow B shown in that Figure.

The lever member 244 is operationally connected to the travel bar 245 by means of an intermediate connector 267. The intermediate connector 267 is a generally elongated member with a crook 268, 270 formed at each end. A lateral jog 272 is formed in the intermediate connector 267 to allow the intermediate connector 267 to pass around and slide back and forth past the rivet 216 that is closest to the open end of the housing 211. The crook 270 at the end of the intermediate connector 267 closest to the open end of the housing 211 passes through eyelet 278 (see FIG. 16) in the endwall 250 of the lever member 244, and the crook 268 at the opposite end of the intermediate connector 267 fits within a groove 247 formed in the end of the travel bar 245 that is closest to the lever 215.

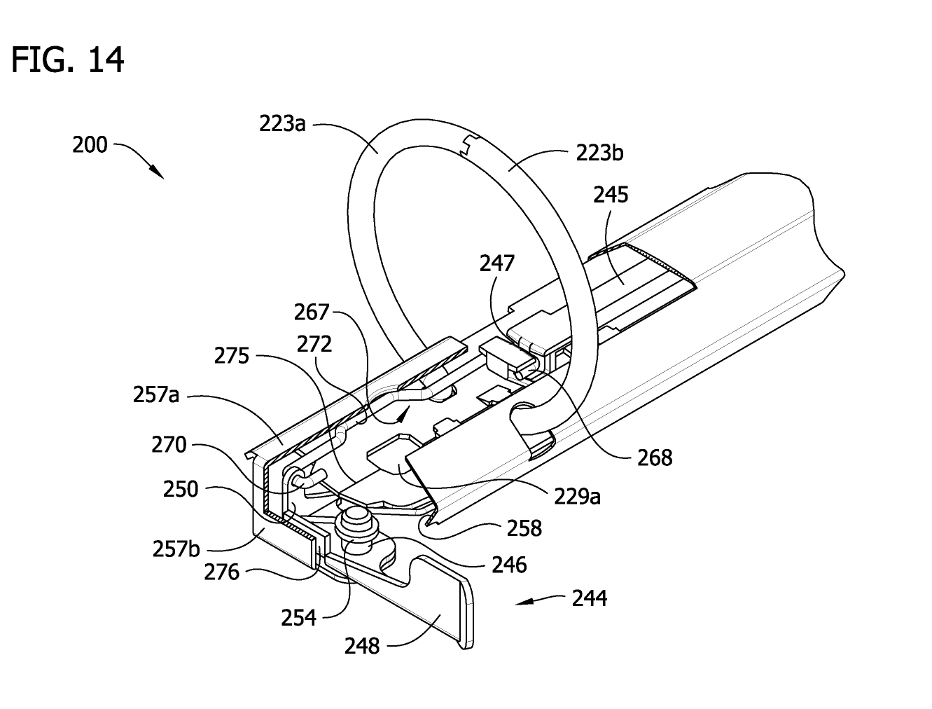

Operation of the second embodiment 200 if a ring mechanism according to the invention will now be described with reference to FIGS. 14-20. In FIGS. 14-16, the ring mechanism 200 is in a closed and locked position. The hinge plates 227a, 227b are hinged downward (only one being shown in FIG. 16), away from housing 211, so that the ring members 223a, 223b of each ring 213 are together in a continuous, circular loop, capable of retaining loose-leaf pages. The lever member 244 is in a first angular position, with the camming surface 252 spaced slightly away from the underside of extension 231 of hinge plate 227a (as best seen in FIG. 16). The locking elements 249 of the travel bar 245 are positioned adjacent respective locking element openings 229b, 229c, and 229d (229c and 229d not shown) and above the hinge plates 227a, 227b generally aligned with the hinge 275. The locking elements 249 are substantially out of registration with the openings 229b, 229c, and 229d. The flat bottom surfaces 253 of the locking elements 249 rest on an upper surface of the hinge plates 227a, 227b and the rearward extensions 256 extend through each respective opening 229b, 229c, 229e adjacent down-turned tabs 282 of the plates. The pivot spring 254 biases the lever member 244 into the position shown in FIG. 15 and thus, acting through the intermediate connector 267, holds the travel bar 245 and the locking elements 249 in this position, with rearward extensions 256 of the locking elements 249 limiting movement of the travel bar 245 toward the lever member 244. Together, the travel bar 245 and locking elements 249 oppose any force tending to pivot the hinge plates 227a, 227b upward to open the ring members 223a, 223b (i.e., they lock the ring members closed).

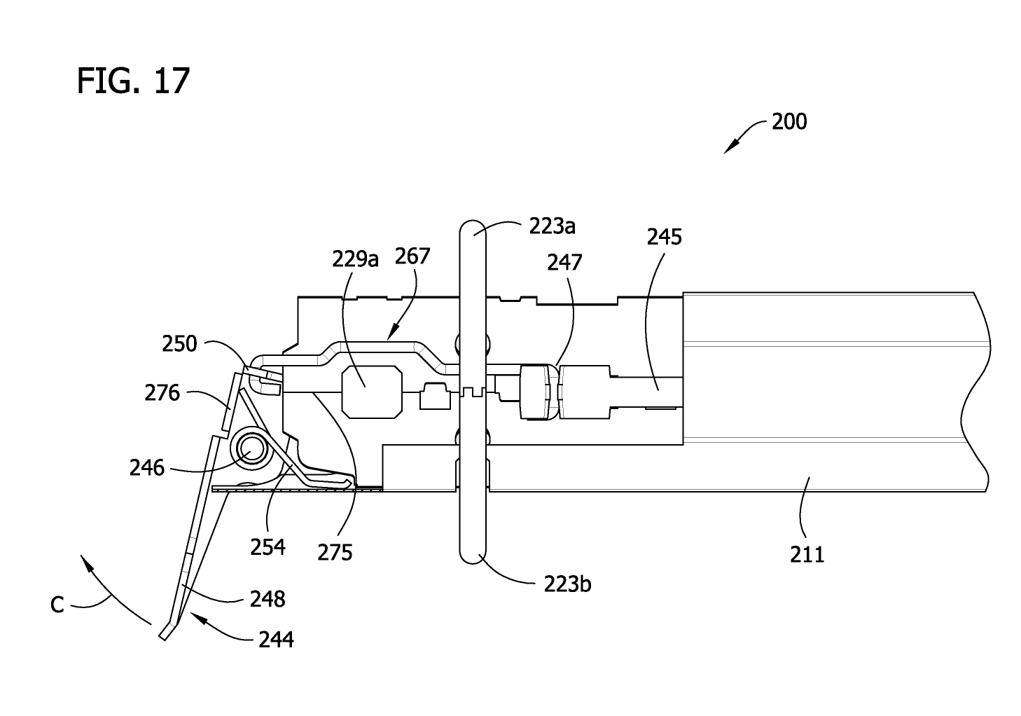

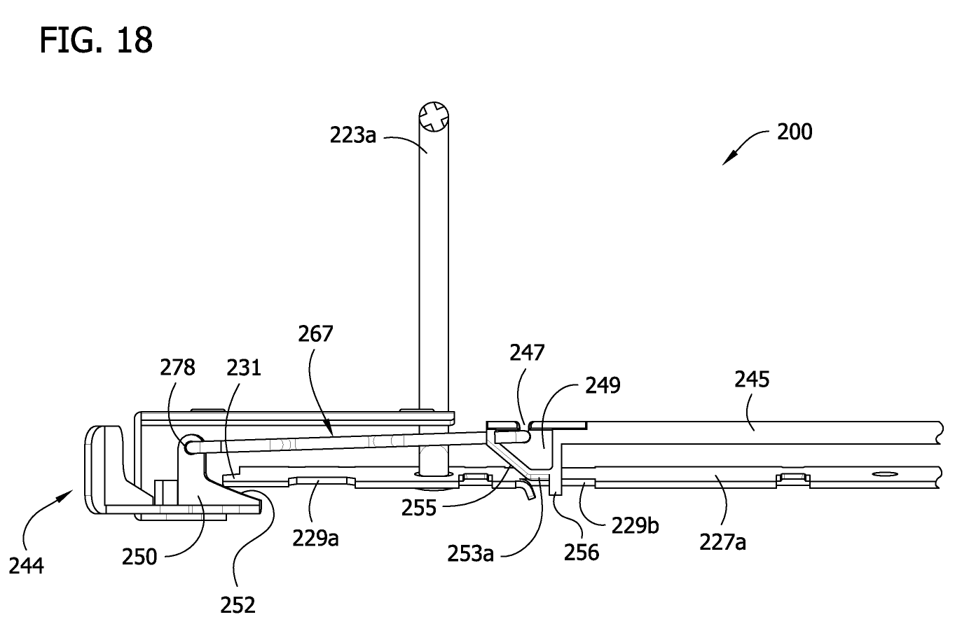

To unlock the ring mechanism 200 and open the ring members 223a, 223b, an operator applies force to the grip portion 248 of the lever member 244 and pivots it about pivot pin 246 against the biasing force of pivot spring 254, from the lateral side of the housing on which it rests toward the opposite side of the housing 211 (e.g., in the direction of arrow C in FIGS. 15 and 17). In other words, the lever member 244 pivots about an axis that is oriented perpendicularly to the longitudinal axis of the housing and that extends upwardly relative to the housing. The intermediate connector 267 is simultaneously pushed by the end wall 250 away from the lever 215. The travel bar 245 slides and moves the locking elements 249 into registration over the respective locking element openings 229b, 229c, and 229d of the hinge plates 227a, 227b, as shown in FIG. 18. Notably, because the camming surface 252 is spaced from the hinge plate extensions 231 when the lever member 244 is in its at-rest position, as best shown in FIG. 16, when the lever member 244 rotates through this initial portion of the opening movement, no opening force is applied to the hinge plates 227a, 227b; this allows the travel bar 245 to slide easily into the position shown in FIG. 18, i.e. without the locking elements 249 binding against the upper surfaces of the hinge plates 227a, 227b.

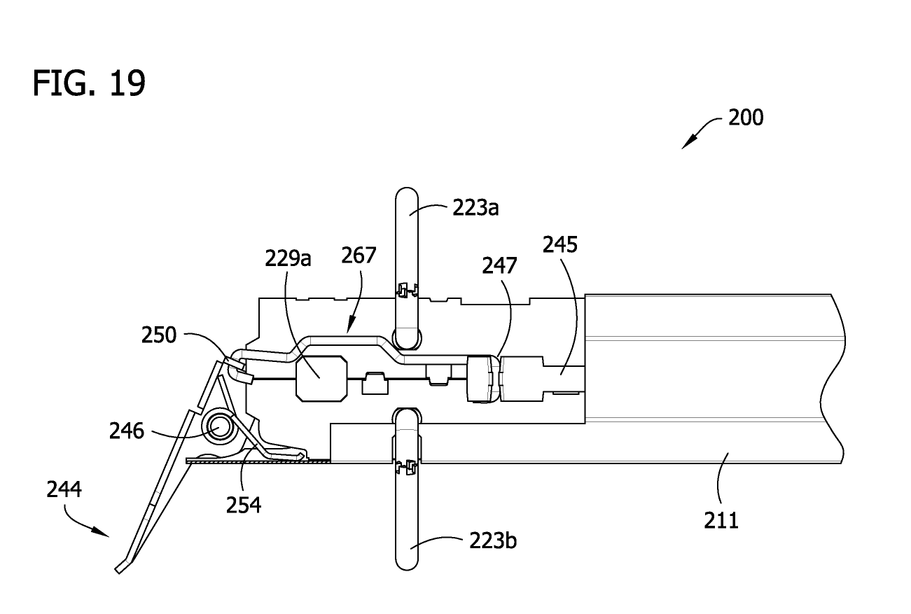

Continued rotation of the lever member 244 causes the camming surface 252 of the end wall 250 to press upward on the lower surface of the hinge plate extension 231 of hinge plate 227a. Because the hinge plates 227a, 227b are linked along hinge line 275, that pressure acts on both hinge plates 227a, 227b and causes them to pivot upward over the locking elements 249 at the locking element openings 229b, 229c, 229e and relative to the rivet 216 at the opening 229a. Once the hinge plates 227a, 227b pass just through the co-planar position, the housing spring force pushes them upward, opening the ring members 223a, 223b and holding them open (FIGS. 19-21), and the lever member 244 can be released.

To close the ring members 223a, 223b and return the mechanism 200 to the locked position, an operator can pivot the lever member 244 in the opposite direction. The end wall 250, acting through the intermediate connector 267, pulls the travel bar 245 toward the lever 215 to seat the forward edges 255 of the locking elements 249 against the tabs 282 of the hinge plates 227a, 227b (if they are not already seated). As the lever member 244 continues to pivot, the angled forward edges 255 of the locking elements 249 bearing against the tabs 282 act to push the hinge plates 227a, 227b downward. Once the hinge plates 227a, 227b pass just through the co-planar position, the housing 211 spring force pushes them all the way downward, thus closing the ring members 223a, 223b. The spring 254 moves the lever 215 and travel bar 245 to the closed and locked position.

As with the first embodiment described above, in the illustrated mechanism 200, the ring members 223a, 223b can also be closed by manually pushing the free ends 225a, 225b of the ring members together. It will be understood that the embodiments of the invention described herein obtain several advantages. One advantage is that the length of the lever 115, 215 is not restricted to the height of the rings in situations where the ring mechanism 100, 200 is mounted on a front or back cover of a notebook.

When introducing elements of the ring binder mechanisms herein, the articles “a”, “an”, “the” and “said” are intended to mean that there are one or more of the elements. The terms “comprising”, “including” and “having” and variations thereof are intended to be inclusive and mean that there may be additional elements other than the listed elements. Moreover, the use of “upward” and “downward” and variations of these terms, or the use of other directional and orientation terms, is made for convenience, but does not require any particular orientation of the components.

As various changes could be made in the above without departing from the scope of the invention, it is intended that all matter contained in the above description and shown in the accompanying drawings shall be interpreted as illustrative and not in a limiting sense.

What is claimed is:

1. A ring mechanism for holding loose-leaf pages, the ring mechanism comprising:
a housing having a longitudinal axis;
a pair of hinge plates supported within the housing for pivoting movement relative to the housing between a first hinge plate position corresponding to a closed configuration of the mechanism and a second hinge plate position corresponding to an open configuration of the mechanism, each of said hinge plates supporting thereon two or more ring members, wherein each of the ring members on one of said hinge plates engages a corresponding ring member on the other of said hinge plates to form a continuous ring when the hinge plates are in said first hinge plate position and the mechanism is in said closed configuration; and
a lever pivotally connected to said housing and arranged to pivot about an axis oriented perpendicularly to the longitudinal axis of the housing and extending upwardly relative to the housing, the lever having a camming surface which engages at least one of said hinge plates to drive the hinge plates from one of said first and second hinge plate positions to the other of said first and second hinge plate positions when the lever pivots from a first lever position to a second lever position.

2. The ring mechanism of claim 1, wherein the camming surface is sloped.

3. The ring mechanism of claim 2 wherein the camming surface constitutes a first camming surface shaped and arranged for moving the hinge plates from the first hinge plate position to the second hinge plate position, the mechanism further comprising a second camming surface shaped and arranged for moving the hinge plates from the second hinge plate position to the first hinge plate position.

4. The ring mechanism of claim 2, wherein the lever is located generally at a longitudinal end of the housing.

5. The ring mechanism of claim 4 further comprising a pivot pin attached to the housing and pivotally mounting the lever.

6. The ring mechanism of claim 1, further comprising a locking member which slides within said housing and which has a locking element extending therefrom, said locking member being coupled to said lever in a manner such that 1) when the lever is in said first lever position, the locking member occupies a first locking member position in which the locking element blocks pivoting movement of said pivot plates, and 2) when the lever is in said second lever position, the locking member occupies a second locking member position in which the locking element extends into a locking element opening in the hinge plates.

7. The ring mechanism of claim 6 further comprising an intermediate connector connected at one end to the lever and connected at an opposite end to the locking member.

8. The ring mechanism of claim 1, wherein said lever comprises a barrel with a generally helical slot formed in a sidewall thereof and a handle extending from said barrel and said hinge plates comprise fingers extending from ends thereof, said camming surface being provided by a surface of said helical slot and said fingers being received within said generally helical slot.

9. The ring mechanism of claim 8, further comprising a locking member which slides within said housing and which has a locking element extending therefrom, said locking member being coupled to said lever in a manner such that 1) when the lever is in said first lever position, the locking member occupies a first locking member position in which the locking element blocks pivoting movement of said pivot plates, and 2) when the lever is in said second lever position, the locking member occupies a second locking member position in which the locking element extends into a locking element opening in the hinge plates.

10. The ring mechanism of claim 9, wherein said generally helical slot has a tail portion that is aligned with or parallel to lower and upper surfaces of the barrel, whereby rotation of said lever from said first lever position toward said second lever position initially causes said locking member to begin moving from said first locking member position toward said second locking member position before causing said hinge plates to pivot from said first hinge plate position toward said second hinge plate position.

11. The ring mechanism of claim 10, further comprising a spring which biases said locking member toward said first locking member position.

12. The ring mechanism of claim 11, wherein said spring is attached at one end to at least one of said hinge plates and at an opposite end to said locking member.

13. The ring mechanism of claim 1, wherein said lever comprises an upstanding wall and said camming surface is formed by an upper surface of said upstanding wall.

14. The ring mechanism of claim 13, further comprising a locking member which slides within said housing and which has a locking element extending therefrom, said locking member being coupled to said lever in a manner such that 1) when the lever is in said first lever position, the locking member occupies a first locking member position in which the locking element blocks pivoting movement of said pivot plates, and 2) when the lever is in said second lever position, the locking member occupies a second locking member position in which the locking element extends into a locking element opening in the hinge plates.

15. The ring mechanism of claim 14, wherein said lever is spaced from ends of said hinge plates such that when said lever is in said first lever position a gap exists between said camming surface and an end of one of said hinge plates whereby rotation of said lever from said first lever position toward said second lever position initially causes said locking member to begin moving from said first locking member position toward said second locking member position before causing said hinge plates to pivot from said first hinge plate position toward said second hinge plate position.

16. The ring mechanism of claim 13, further comprising a pivot spring which biases said lever toward said first lever position.

17. The ring mechanism of claim 16 wherein the pivot spring is in contact with the lever.
